(19) United States
(12) Patent Application Publication
(10) Pub. No.: US 2002/0025730 A1
(43) Pub. Date: Feb. 28, 2002

(54) Erroneous insertion prevention mechanism of connectors

(76) Inventors: Hirotaka Otani, Tokyo (JP); Takayasu Takayanagi, Toyko (JP)

Correspondence Address: FLYNN, THIEL, BOUTELL & TANIS, P.C., 2026 Rambling Road, Kalamazoo, MI, 49008-1699, US

(21) Appl. No.: 09/938,004

(22) Filed: Aug. 23, 2001

(30) Foreign Application Priority Data
Aug. 29, 2000 (JP) 2000-259879

(51) Int. Cl. H01R 13/64

(52) U.S. Cl. 439/680

(57) ABSTRACT

An erroneous insertion prevention mechanism of connectors is provided for preventing the erroneous insertion between engagement fixed tables provided on both ends of a cable and engagement sections provided on the devices or units by changing the shapes and installing positions thereof. The erroneous insertion prevention mechanism of connectors comprises engagement fixed tables of an engagement connector, engagement fixed tables of an engagement connector, guide rings and manually screwing screws, guide rings and manually screwing screws respectively mounted on both ends of the cable, wherein the shapes of the engagement fixed tables are differentiated from each other and they are provided at the positions where they are displaced from the center of the engagement connector.

### BACKGROUND OF THE INVENTION

1. Field of the Invention

The invention relates to an erroneous insertion prevention mechanism of connectors for connecting between devices or units mounted on a device using a cable.

2. Related Art

For connectors used for connecting between units mounted on a device and the like using a cable, there has been known those which are guided in insertion and extraction direction (hereinafter referred to insertion/extraction direction) by guide pins and the like so that a connector at a cable side is connected to a connector at a unit side. FIG. 5 is a perspective view showing the construction of connectors of this type. In the same figure, depicted by 1A, 1B are units which are connected by a cable. An engagement connector 2A installed on a panel surface of the unit 1A has guide tables 3A, 3B while an engagement connector 2B installed on a panel surface of the unit 1B has guide tables 3C, 3D.

An engagement connector box 11A having a engagement connector 12A is installed on one end of a connection cable while an engagement connection box 11B having a engagement connector 12B is installed on the other end of the connection cable. Guide pins 13A, 13B of the engagement connector box 11A are guided by the guide tables 3A, 3B in the insertion/extraction direction and the engagement connector 12A is connected to the engagement connector 2A. Meanwhile, guide pins 13C, 13D of the engagement connection box 11B are guided by the guide tables 3C, 3D in the insertion/extraction direction, and the engagement connector 12B is connected to the engagement connector 2B.

However, since the guide pins 13C, 13D can be inserted into the guide tables 3A, 3B in the conventional method, there has arisen a case that the engagement connector 12B is erroneously connected to the engagement connector 2A. Likewise, the guide pins 13A, 13B can be inserted into the guide tables 3C, 3D, there arises a case that the engagement connector 12A is erroneously connected to the engagement connector 2B. There has arisen a problem of the application of an excessive voltage by the erroneous insertion of the cable engagement connector, resulting in a trouble of the devices or units. Further, since only the guide pins are engaged in the guide tables in the engagement portions, there has arisen another problem that the engagement connectors are easily come off.

### SUMMARY OF THE INVENTION

The invention has been developed to solve the foregoing problems and it is an object of the invention to provide an erroneous insertion prevention mechanism of connectors for preventing erroneous insertion between engagement connectors of the unit side and those of the cable side. It is another object of the invention to provide an erroneous insertion prevention mechanism of connectors for certainly connecting and fixing connectors.

To achieve the above objects, with the erroneous insertion prevention mechanism of connectors for connecting between devices or units mounted on a device using a cable, it comprises as first means, engagement sections provided on upper and lower portions of first connectors mounted on both ends of the cable while displaced from each center of the first connectors, and engagement fixed tables provided on upper and lower portions of second connectors mounted on the devices or units while displaced from each center of the second connectors for guiding the engagement sections in an insertion/extraction direction so as to connect the first connectors to the second connectors.

As second means, with the erroneous insertion prevention mechanism of connectors according to the first means, the engagement sections are guide rings and the engagement fixed tables are protrusions for guiding the guide rings in an insertion/extraction direction so as to connect the first connectors to the second connectors.

As third means, with the erroneous insertion prevention mechanism of connectors according to first or second means, the engagement fixed tables are cylindrical or polygonal protrusions and the guide rings are hollow cylindrical or hollow polygonal rings which are opened at end surface for receiving the engagement fixed tables.

As fourth means, with the erroneous insertion prevention mechanism of connectors according to any of first to third means, the upper engagement fixed tables of second connectors are different from lower engagement fixed tables of second connectors in shapes or dimensions and upper engagement sections of first connectors are different from lower engagement section of first connectors in shapes or dimensions.

As fifth means, with the erroneous insertion prevention mechanism of connectors according to any of first to fourth means, the screws are freely slidably provided on the guide rings of the first connectors and screw holes are provided on the engagement fixed tables for receiving the screws wherein the first connectors are screwed into the engagement fixed tables received by the guide rings.

### BRIEF DESCRIPTION OF THE DRAWINGS

FIG. 1 is a perspective view showing the construction of an erroneous insertion prevention mechanism of connectors according to a preferred embodiment of the invention;

FIG. 2 is a sectional view of the erroneous insertion prevention mechanism and the connectors according to the preferred embodiment of the invention;

FIG. 3 is a sectional view of the erroneous insertion prevention mechanism and the connectors according to the preferred embodiment of the invention;

FIG. 4 is a schematic front view of the erroneous insertion prevention mechanism and the connectors according to the preferred embodiment of the invention; and

FIG. 5 is a perspective view showing the construction of conventional connectors.

### PREFERRED EMBODIMENT OF THE INVENTION

An erroneous insertion prevention mechanism of connectors according to a preferred embodiment of the invention is now described with reference to the attached drawings.

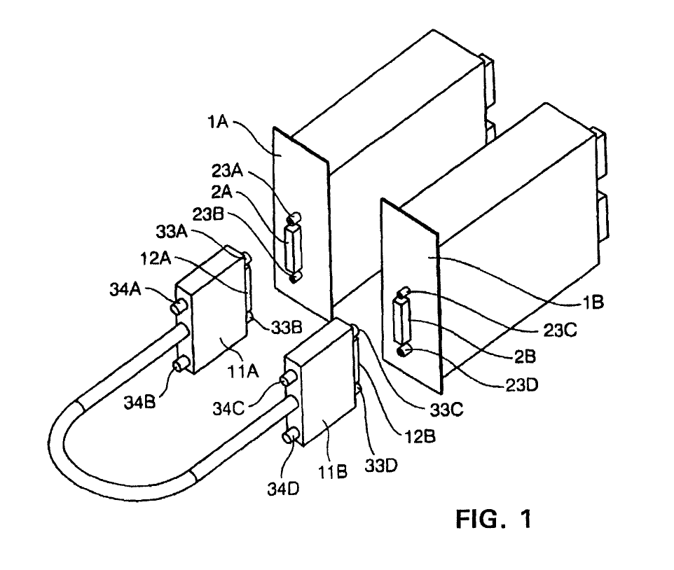

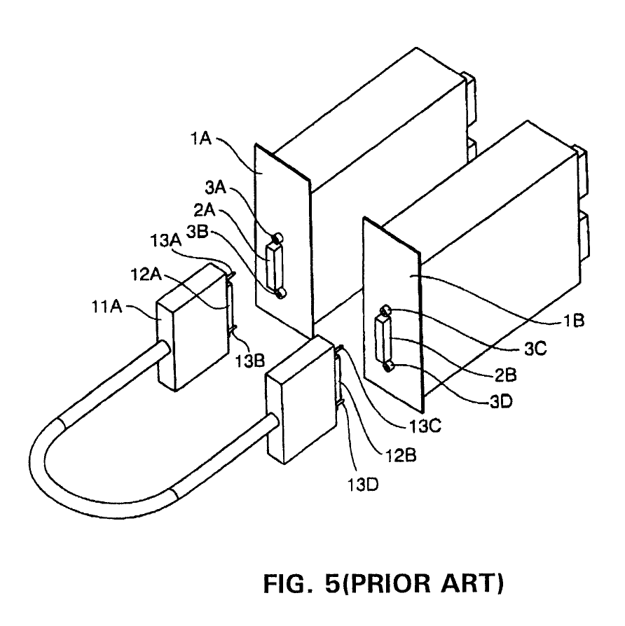

FIG. 1 is a perspective view showing the construction of an erroneous insertion prevention mechanism of connectors according to a preferred embodiment of the invention. In the same figure, components which are common to those shown in FIG. 5 are depicted by the same reference numerals, and the explanation thereof is omitted. The erroneous insertion prevention mechanism of connectors according to the preferred embodiment of the invention comprises engagement fixed tables 23A, 23B provided on an engagement connector 2A of one unit 1A, and guide rings 33A, 33B and manually screwing screws 34A, 34B sliding in the guide rings 33A, 33B respectively provided on an engagement connector box 11A on one end of a cable, and further it comprises engagement fixed tables 23C, 23D provided on an engagement connector 2B of the other unit 1B, and guide rings 33C, 33D and manually screwing screws 34C, 34D sliding in the guide rings 33C, 33D respectively provided on an engagement connector box 11B on the other side of the cable.

The engagement fixed tables 23A, 23B are formed respectively in a cylindrical shape and have different diameters. The guide rings 33A, 33B engaged in the engagement fixed tables 23A, 23B are formed in a hollow cylindrical shape and have different diameters in accordance with the sizes of the engagement fixed tables 23A, 23B. Further, attachment positions of the engagement fixed tables 23A, 23B are set to be displaced by a given length from the center of the engagement connector 2A.

Likewise, the engagement fixed tables 23C, 23D are formed respectively in a cylindrical shape and have different diameters. The guide rings 33C, 33D engaged in the engagement fixed tables 23C, 23D are formed in a hollow cylindrical shape and have different diameters in accordance with the sizes of the engagement fixed tables 23C, 23D. Further, attachment positions of the engagement fixed tables 23C, 23D are set to be displaced by a given length from the center of the engagement connector 2B.

Both the engagement connector box 11A and the engagement connector 12A and the engagement connection box 11B and the engagement connector 12B are respectively mounted on both ends of the cable. When the engagement connector 12A is connected to the engagement connector 2A while the engagement connector 12B is connected to the engagement connector 2B, both the unit 1A and the unit 1B are electrically correctly connected to each other.

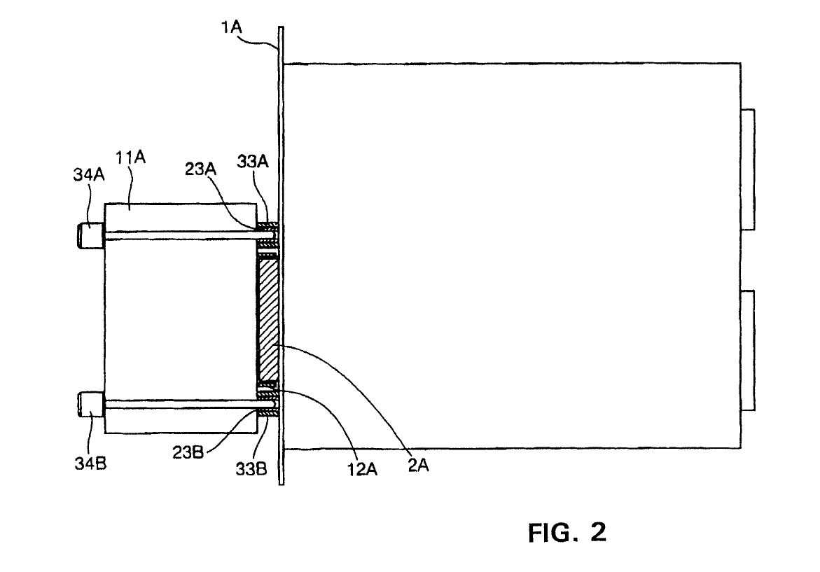

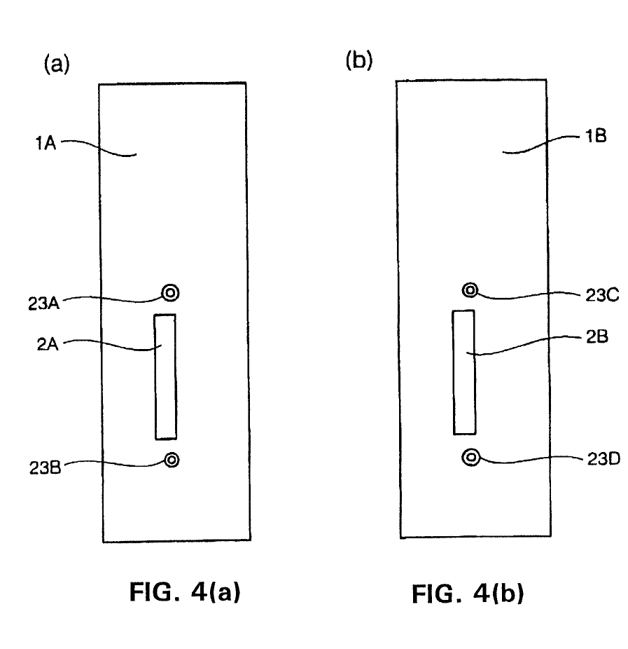

FIG. 2 is a sectional view showing a state where the engagement connector box 11A provided the engagement connector 12A is connected to the engagement connector 2A of the unit 1A. When the engagement connector 12A and the engagement connector 2A are connected to each other, the guide rings 33A, 33B provided in the engagement connector box 11A are guided by the engagement fixed tables 23A, 23B in the insertion/extraction direction. As shown in the front view of the unit 1A of FIG. 4(a), diameters of the engagement fixed tables 23A, 23B are different from each other and the installing positions thereof are displaced from the center of the engagement connector 2A. Accordingly, the engagement connector box 11A can be inserted into the engagement connector 2A only in the corrected engagement direction.

In a state where the engagement connector box 11A is turned 180° from the corrected engagement position, the engagement fixed tables 23A, 23B can not guide the guide rings 33A, 33B. Further, since the engagement fixed tables 23A, 23C and the engagement fixed tables 23B, 23D are differentiated from each other in shapes or dimensions, the engagement connector 12B can not be connected to the engagement connector 2A. After the engagement connector 12A is engaged with the engagement connector 2A, they are screwed with each other by the manually screwing screws 34A, 34B.

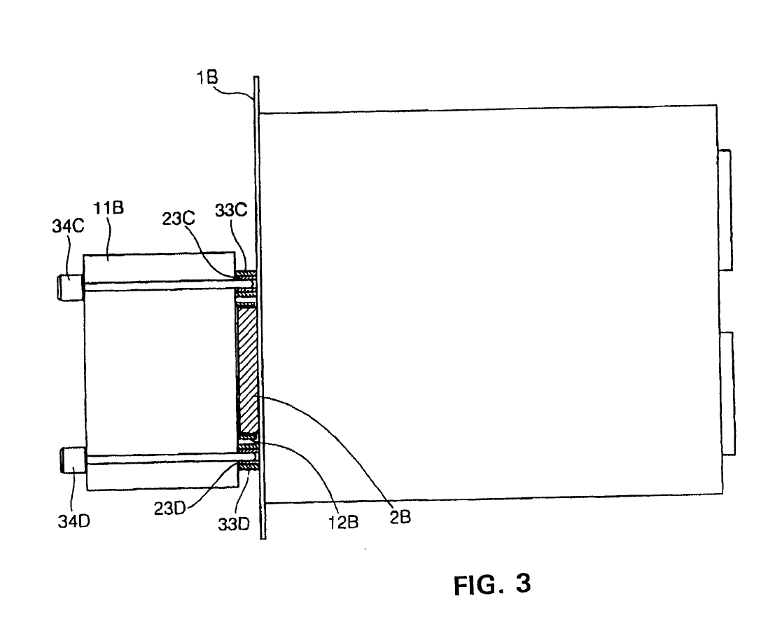

FIG. 3 shows a state where the engagement connection box 11B provided with the engagement connector 12B is connected to the engagement connector 2B of the unit 1B. When the engagement connector 12B is connected to the engagement connector 2B, the guide rings 33C, 33D provided in the engagement connection box 11B are guided by the engagement fixed tables 23C, 23D in the insertion/extraction direction. As shown by the front view of the unit 1B of FIG. 4(b), the diameters of the engagement fixed tables 23C, 23D are differentiated from each other and the installation positions thereof are displaced from the center of the engagement connector 2B.

Accordingly, the engagement connection box 11B can be inserted into the engagement connector 2B only in a correct engagement direction in the same manner as the case of the unit 1A, and hence the former can not be inserted into the latter when the engagement connection box 11B is turned 180°. After the engagement connector 12B and the engagement connector 2B are engaged with each other, they are screwed with each other by the manually screwing screws 34C, 34D.

The engagement fixed tables 23A, 23D and the engagement fixed tables 23B, 23C may have the same shapes for easily manufacturing the erroneous insertion prevention mechanism of connectors. In this case, the shapes of the guide rings 33A, 33D have the same shapes as the guide rings 33B, 33C. If the installing positions of the engagement fixed tables are displaced from the central position of each connector, the erroneous insertion of the engagement connectors can be prevented even if the engagement fixed tables having the same shapes are used.

Although the engagement fixed tables 23A, 23B and the engagement fixed tables 23C, 23D are formed in the cylindrical shape respectively, and the guide rings 33A, 33B and the guide rings 33C, 33D to be engaged with the engagement fixed tables 23A, 23B and the engagement fixed tables 23C, 23D are formed in the hollow cylindrical shape respectively according to the preferred embodiment of the invention, the invention is not limited to these shapes. The engagement fixed tables 23A, 23B and the engagement fixed tables 23C, 23D may be formed in a polygonal protrusion and the guide rings 33A, 33B and the guide rings 33C, 33D may be in a hollow polygonal shape so as to be engaged with the engagement fixed tables 23A, 23B and the engagement fixed tables 23C, 23D.

As mentioned above, according to the erroneous insertion prevention mechanism of connectors of the invention, since it comprises engagement sections provided on upper and lower portions of first connectors mounted on both ends of the cable while displaced from each center of the first connectors, and engagement fixed tables provided on upper and lower portions of second connectors mounted on the devices or units while displaced from each center of the second connectors for guiding the engagement sections in an insertion/extraction direction so as to connect the first connectors to the second connectors, the erroneous insertion of the connectors can be prevented so that a trouble caused by the erroneous insertion of the connectors can be prevented, thereby enhancing a reliability of the devices or units. Further, the connectors mounted on the cable can be certainly fixed to the connectors mounted on the devices or units by screwing, it is possible to prevent the devices or units from deterioration in performance such as entrance of a noise caused by the unstable contact between the engagement sections of devices or units and those of the cable.

What is claimed is:

1. An erroneous insertion prevention mechanism of connectors for use in connecting between units mounted on a device using a cable, said mechanism comprising:
engagement sections provided on upper and lower portions of first connectors mounted on both ends of the cable while displaced from each center of the first connectors; and
engagement fixed tables provided on upper and lower portions of second connectors mounted on the units while displaced from each center of the second connectors for guiding the engagement sections in an insertion/extraction direction so as to connect the first connectors to the second connectors.

2. The erroneous insertion prevention mechanism of connectors according to claim 1, wherein the engagement sections are guide rings and the engagement fixed tables are protrusions for guiding the guide rings in an insertion/extraction direction so as to connect the first connectors to the second connectors.

3. The erroneous insertion prevention mechanism of connectors according to claim 1 or 2, wherein the engagement fixed tables are cylindrical or polygonal protrusions and the guide rings are hollow cylindrical or hollow polygonal rings which are opened at each end surface thereof for receiving the engagement fixed tables.

4. The erroneous insertion prevention mechanism of connectors according to any of claims 1 to 3, wherein the upper engagement fixed tables of the second connectors are different from the lower engagement fixed tables of the same in shapes or dimensions and the upper engagement sections of the first connectors are different from the lower engagement section of the same in shapes or dimensions.

5. The erroneous insertion prevention mechanism of connectors according to any of claims 1 to 4, wherein screws are freely slidably provided on the guide rings of the first connectors and screw holes are provided on the engagement fixed tables for receiving the screws wherein the first connectors are screwed into the engagement fixed tables received by the guide rings.
